(19) United States
(12) Patent Application Publication
(10) Pub. No.: US 2010/0200569 A1
(43) Pub. Date: Aug. 12, 2010

(54) CONTROLLED FORCE PTC HEATER

(75) Inventors: Howard J. Base, Macedonia, OH (US); Derrick L. Sanislo, Thompson, OH (US)

Correspondence Address: FAY SHARPE LLP, 1228 Euclid Avenue, 5th Floor, The Halle Building, Cleveland, OH, 44115, US

(73) Assignee: Tom Richards, Inc.

(21) Appl. No.: 12/370,126

(22) Filed: Feb. 12, 2009

(51) Int. Cl. H05B 3/06

(52) U.S. Cl. 219/550

(57) ABSTRACT

A self-regulating heater assembly comprises a positive temperature coefficient (PTC) heating element and a pair of spaced electrodes. Each electrode includes a first surface. The first surfaces of the pair of electrodes are spaced from one another. The PTC element is located between and supported by the first surfaces of the pair of electrodes and is energized by the pair of electrodes. Means for limiting a compressive force on the PTC element is provided. The means includes an electrically insulative spacer member positioned between the first surfaces of the pair of electrodes. A first pair of power leads, one power lead being connected to each of the pair of electrodes, energizes the pair of electrodes.

### BACKGROUND

The present disclosure relates generally to a heater assembly and more particularly to a self-regulating heater assembly which includes a positive temperature coefficient heating device and is adapted for use in hostile environments.

Self-regulating heater assemblies are well known in the art. A positive temperature coefficient (PTC) heating device is a semiconductor which has an electrical resistance that is temperature sensitive. The electrical resistance of the PTC device varies proportionately with temperature. PTC devices are generally available as ceramics or polymers and are well known for use in temperature sensors, current limiters and heaters. Their usefulness as a heater is particularly attractive due to the fact that a self regulating heater can be constructed. When a current is passed through a PTC device, it produces heat by virtue of the internal resistance of the PTC device and the resultant current is similar to that of other resistance heaters except that at a certain predetermined temperature (curie point or autostabilizing temperature), the resistance begins to increase virtually exponentially, causing the power to decrease. Thus, the PTC device autostabilizes at a particular predetermined temperature. The temperature at which the PTC device autostabilizes will vary depending upon the specific PTC device.

PTC devices operate in a very precise manner based upon the temperature of the device. When heat is effectively transferred from the device to its surrounding, the total power output goes up following the R/T (resistance vs. temperature) curve of the device. If the heat generated by the device is not removed, its temperature increases causing the resistance to increase thereby reducing total power output.

To achieve the maximum power output of the PTC thermistor heater assembly, good heat transfer is paramount. The PTC device electrical properties can be affected by pressure applied to the PTC element. Increased force on the element can increase the resistance of the element by as much as 50% over an unloaded element. The increased load also affects the R/T curve, shifting the curve to a higher temperature which can result in premature failure of the PTC element. Such increased resistance along with the higher switch temperature reduces the effective output of the PTC device.

Further, due to the precise requirements of pressure on the PTC device for optimum performance, variations in thickness of the assembled components can present a major problem. If the PTC element is too thick or a spacer, which limits a compressive force on the PTC element, is too thin, too much force can be applied to the PTC device. If the PTC element is too thin and the spacer too thick, insufficient force will be applied to the PTC device resulting in poor electrical and thermal contact.

Accordingly, it is desirable to develop an improved self-regulating heater assembly which would overcome the foregoing concerns and difficulties and others while providing better and more advantageous overall results.

### BRIEF DESCRIPTION

According to one embodiment of the present disclosure, a self-regulating heater assembly comprises a positive temperature coefficient (PTC) heating element and a pair of spaced electrodes. Each electrode includes a first surface. The first surfaces of the pair of electrodes are spaced from one another. The PTC element is located between and supported by the first surfaces of the pair of electrodes and is energized by the pair of electrodes. Means for limiting a compressive force on the PTC element is provided. The means includes an electrically insulative spacer member positioned between the first surfaces of the pair of electrodes. A first pair of power leads, one power lead being connected to each of the pair of electrodes, energizes the pair of electrodes.

According to another embodiment of the present invention, a self-regulating heater assembly comprises a plurality of spaced heating sections. Each heating section comprises a positive temperature coefficient (PTC) heating element and a pair of spaced apart electrodes. The pair of spaced apart electrodes supports and energizes the PTC element. Each electrode has a generally planar first surface and a second surface. An electrically insulative spacer member is positioned between the first surfaces of the pair of electrodes. An electrically and thermally conductive, compressible interface pad is in contact with a surface of the PTC element and disposed between the PTC element and at least one of the pair of electrodes. At least one pair of power leads, one being connected to each of the pair of electrodes of each of the plurality of spaced heating sections, energizes each of the heating sections.

According to yet another embodiment of the present disclosure, a self-regulating heater assembly comprises a positive temperature coefficient (PTC) heating element and a pair of spaced electrodes. Each electrode includes a first surface. The first surfaces of the pair of electrodes are spaced from one another. The PTC element is located between and supported by the first surfaces of the pair of electrodes and is energized by the pair of electrodes. A stake connects the pair of electrodes. The stake is oriented generally normal to the first surfaces of the pair of electrodes and comprises an electrically insulative material. A first pair of power leads, one power lead being connected to each of the pair of electrodes, energizes the pair of electrodes.

### BRIEF DESCRIPTION OF THE DRAWINGS

FIG. 1 is a perspective view of a self-regulating heater assembly according to the present disclosure in a partially assembled condition.

FIG. 2 is a partially exploded perspective view of the heating sections of the self-regulating heater assembly of FIG. 1.

FIG. 3 is an enlarged exploded perspective view of a heating section of FIG. 2 according to one aspect of the present disclosure.

FIG. 4 is a perspective view of the heating section of FIG. 3 in an assembled condition.

FIG. 5 is a partial cross-sectional view of the self-regulating heater assembly of FIG. 1 including the heating sections of FIG. 3.

FIG. 6 is an enlarged exploded perspective view of a heating section of FIG. 2 according to another aspect of the present disclosure.

FIG. 7 is an enlarged exploded perspective view of a heating section of FIG. 2 according to yet another aspect of the present disclosure.

FIG. 8 is an enlarged exploded perspective view of a heating section of FIG. 2 according to still yet another aspect of the present disclosure.

FIG. 9 is an enlarged exploded perspective view of a heating section of FIG. 2 according to still yet another aspect of the present disclosure.

FIG. 10 is an enlarged exploded perspective view of a heating section of FIG. 2 according to still yet another aspect of the present disclosure.

FIG. 11 is an enlarged perspective view of a heating section of FIG. 2 in an assembled condition according to still yet another aspect of the present disclosure.

### DETAILED DESCRIPTION

It should, of course, be understood that the description and drawings herein are merely illustrative and that various modifications and changes can be made in the structures disclosed without departing from the present disclosure. It will also be appreciated that the various identified components of the self-regulating heater assembly disclosed herein are merely terms of art that may vary from one manufacturer to another and should not be deemed to limit the present disclosure.

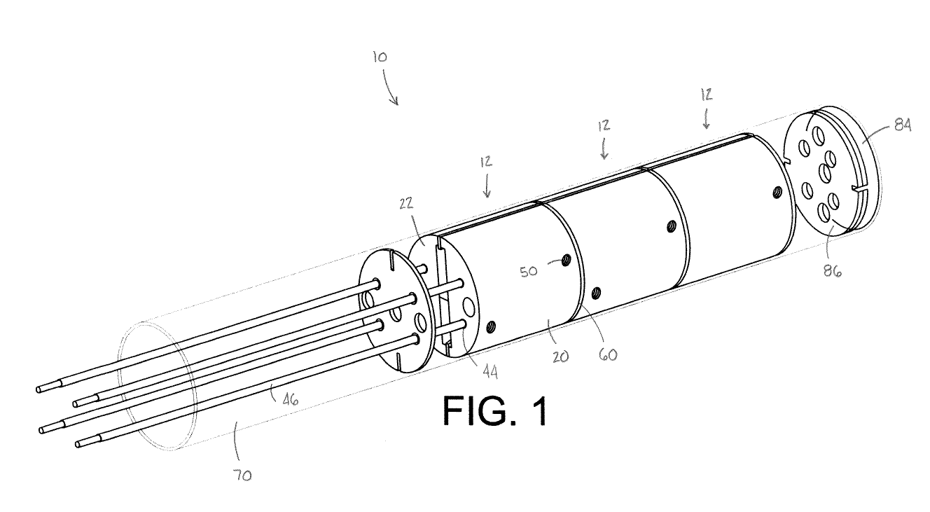

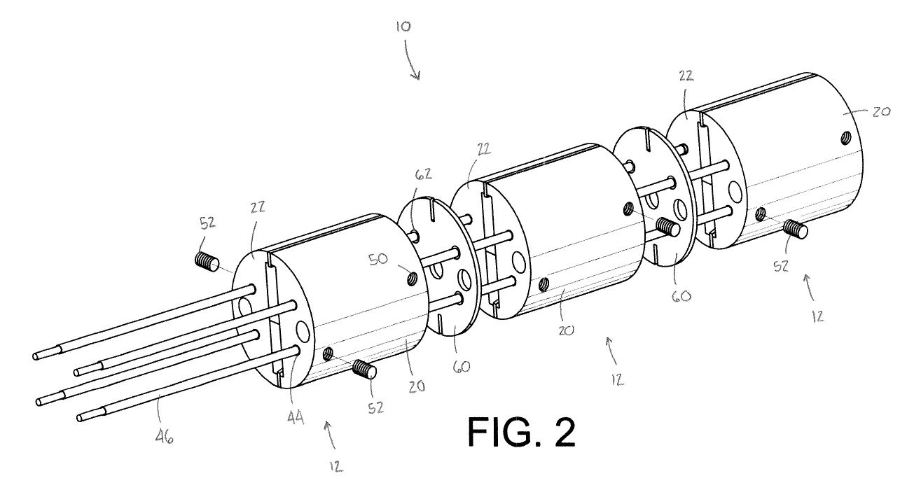

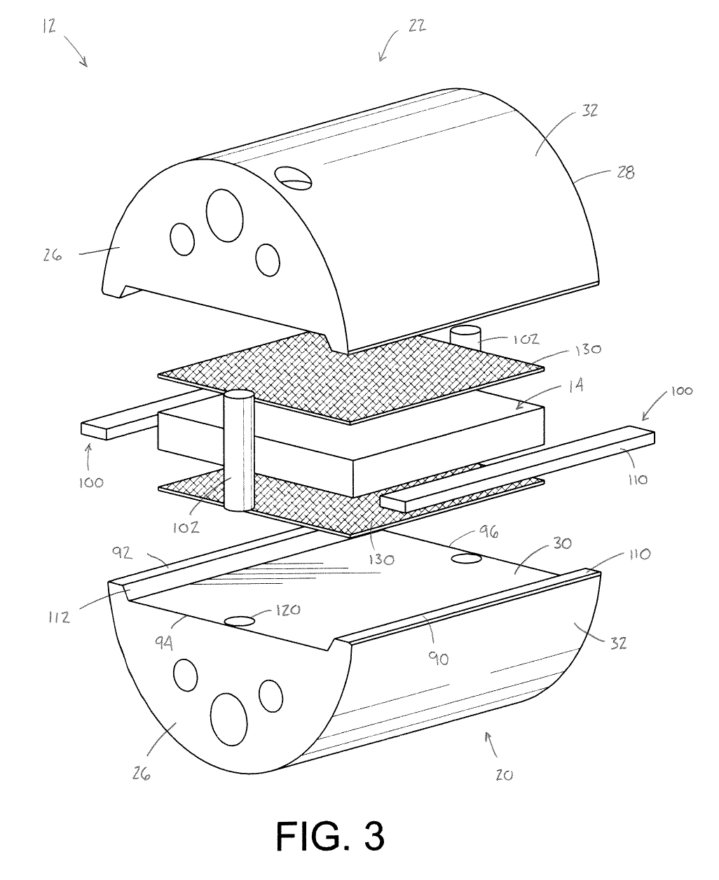

Referring now to drawings, wherein like numerals refer to like parts throughout the several views, a self-regulating heater assembly 10 in accordance with the present disclosure is illustrated in FIGS. 1 and 2. The self-regulating heater assembly 10 comprises a plurality of spaced heating sections 12. Various embodiments of the heating sections will be described in greater detail below. Generally, each heating section includes a positive temperature coefficient (PTC) heating element 14 (see FIG. 3). The PTC element can be rectangular in shape and include a pair of opposed generally parallel planar surfaces 16 and 18 (see FIG. 5). Of course, other geometric shapes for the PTC element are also contemplated, such as, for example, disc-shaped elements.

Each heating section 12 also includes a pair of low electrical resistance current conducting electrodes 20 and 22 for energizing the PTC element. The pair of electrodes 20, 22 can have a length of approximately two inches (5.1 cm). Electrodes of approximately this length typically do not warp excessively as the temperature of the PTC element increases to a predetermined autostabilizing temperature. Of course, the electrodes can be longer or shorter if desired. As shown, the electrodes 20, 22 can each be in the form of a half cylinder. However, the electrodes could take different shapes than the half cylinder shapes illustrated, if so desired. For example, the electrodes could have a hexagonal or rectangular shape in cross-section. More generally, while an approximately cylindrical self-regulating heater assembly 10 is disclosed herein, it should be appreciated that a self-regulating heater assembly according to the present disclosure could also take the form of a plate or a box, if desired, so long as each heating section 12 produces sufficient heat without excess warpage, and so long as the heater 10 can be successfully sheathed with a protective sheath.

The pair of electrodes 20 and 22 is preferably made from a suitable metallic material. Two such materials are an electrical grade copper and aluminum alloys. As shown in FIG. 3, each electrode includes a first end wall 26, a second end wall 28, a first side 30 and a second side 32. The first side can be generally planar and the second side can have a general arcuate contour. However, it can be appreciated by one skilled in the art that the second side of each electrode can have other configurations depending on the end use of the self-regulating heater assembly 10.

At least one pair of power leads, one being connected to each of the pair of electrodes 22, 22 of each of the plurality of spaced heating sections 12, energizes each of the heating sections. Particularly, with reference again to FIGS. 1 and 2, defined on the first and second end walls 26 and 28 of the pair of electrodes 20 and 22 is at least one bore 44 that extends parallel to a longitudinal axis of the electrode and through it. The bore receives a power lead 46 for energizing the pair of electrodes. In this embodiment, each electrode includes two bores 44 for receiving two power leads 46. Of course, more or less than two power leads could be used for energizing each electrode.

The second sides 32 of the pair of electrodes 20 and 22 further include at least one threaded aperture 50 for receiving a set screw 52. As shown in FIG. 2, the set screw threadingly engages the aperture until the set screw contacts the power lead 46. This contact ensures an electrical connection of a power line with the electrode.

A segment spacing member 60 is positioned between the second end walls 28 of one pair of electrodes and the first end walls 26 of an adjacent pair of electrodes of each heating section 12. The segment spacing member 60 can be formed from an electrically insulative and thermally conductive material. It can be flexible for enabling the self-regulating heater assembly 10 to be bent at the segment spacer member. The segment spacing member 60 includes at least one aperture 62 which is aligned with the bore 44 of each electrode 20 and 22 for receiving the respective power lead 46 for each electrode. The segment spacing member can be made of a magnesium silicate material such as steatite which has good electrical resistance properties, which are retained at high temperatures, along with moderate mechanical strength and temperature resistance.

As shown in FIG. 1, the assembled heating sections 12 are inserted in a protective sheath 70 which holds the pair of electrodes 20 and 22 in contact with the planar surfaces 16 and 18 of the PTC element 14. The sheath 70 simplifies the construction of the self-regulating heater assembly 10 by exerting pressure on the pair of electrodes which in turn positively locates the pair of electrodes 20, 22 and the PTC element 14. Not only does sheath 70 maintain substantially uniform contact pressure between the PTC element 14 and the pair of electrodes 20, 22, it also acts to enhance the thermal characteristics of the self-regulating heater assembly 10. The sheath transfers heat from the PTC element 14 to the environment when the PTC element is energized. The sheath 70 further protects the PTC element from hostile environments and physical damage. Moreover, the sheath 70 serves as an electrical conductor and ground path circuit for the self-regulating heater assembly 10 if short-circuiting occurs. To this end, a ground conductor (not shown) can be connected to sheath 70 to serve as a ground path circuit to protect operating personnel in the event of an electrical fault condition.

As indicated previously, the self-regulating heater assembly 10 operates in a very precise manner based upon the temperature of the PTC element 14. When heat is effectively transferred from the heater assembly to its surrounding, the total power output goes up following the R/T (resistance vs. temperature) curve of the PTC element. If the heat generated by the PTC element 14 is not removed, its temperature increases causing the resistance to increase thereby reducing total power output. To achieve the maximum power output of the heater assembly 10, good heat transfer is paramount. To this end, the sheath 70 can be filled with an electrically insulative and thermally conductive fill material 72 (FIG. 5) to fill any remaining voids. The fill material 72 can be formed of magnesium or zirconium oxide, though any suitable electrically insulative and thermally conductive material could be used. Generally, magnesium oxide provides the best possible heat transfer while providing effective electrical insulation between the exposed heater sheath 70 and the electrodes 20, 22. The fill material 72 can be disposed about at least a portion of the second sides 32 of the pair of electrodes 20 and 22, a portion of the first sides 30 thereof, and the side edges and end edges of each PTC element 14. The fill material also protects the PTC element and radiates heat away from the PTC element when the PTC element is energized. With reference to FIG. 5, to maximize both the thermal conductivity and the dielectric strength of the fill material 72, the heater assembly 10 includes a swaged area 74. A portion of the fill material 72 located between the pair of electrodes 20, 22 and the sheath 70 is compressed in the swaged area 74. The swaging process compacts the fill material into a near solid, removing air gaps and voids that impede heat transfer.

A protective sleeve (not shown) can surround the sheath 70 to further protect the self-regulating heater assembly 10 from hostile environments. The sleeve can be a heavy walled sleeve and can be made from a chemical and heat resistant polymer material such as a fluorocarbon polymer, an ethylenated fluorocarbon polymer, a chlorinated fluorocarbon polymer, an ethylenated/chlorinated fluorocarbon polymer, a polyvinyl fluorocarbon polymer, or a perfluoroalkoxy polymer.

The power leads 46 are fed through the bores 44 extending longitudinally through each of the pair of electrodes 20 and 22. The power leads energize the pair of electrodes. To ensure an electrical connection on the electrodes, the set screws 52 are threaded in the threaded apertures 50 of the second sides 32 of the pair of electrodes 20 and 22 until each set screw contacts the respective power lead. When power is provided on the power leads 46, the pair of electrodes 20, 22 will be energized and a circuit will be completed between electrodes via the PTC element 14. As current is passed through the PTC element, the PTC element generates heat by virtue of its internal resistance. The heat is transferred via the pair of electrodes 20, 22, the fill member 72, the sheath 70 and the protective sleeve to the environment, in which self-regulated heater assembly 10 is disposed.

A heat resistant potting compound (not shown) can be placed into an upper portion of the self-regulating heater assembly 10 to seal the upper portion of the self-regulating heater assembly against the fluid in which the heater assembly is immersed. As shown in FIG. 1, a plug or end cap 84 is provided at a lower portion of the self-regulating heater assembly 10 to seal the lower portion. A bottom insulator 86 can be positioned between the second end walls 28 of the electrodes 20, 22 and an upper surface of the end cap 84. The bottom insulator can be made of the same magnesium silicate material as the segment spacing member 60.

With reference to FIGS. 3-5, the heating section 12 according to one aspect of the present disclosure is illustrated in greater detail. As indicated previously, the heating section includes the PTC heating element 14 and the pair of spaced apart electrodes 20, 22. The pair of spaced apart electrodes supports and energizes the PTC element. Each electrode has the generally planar first surface 30 and the second surface 32. Each first surface 30 of the pair of electrodes 20, 22 includes first and second sides 90 and 92, respectively, and first and second transverse ends, 94 and 96, respectively. The first and second sides and the first and second ends together define a periphery of the first surface 30.

As set forth above, electrical properties of the PTC element 14 can be affected by pressure applied to the element. Increased force on the PTC element can increase the resistance of the element by as much as 50% over an unloaded element. The increased load also affects the R/T curve, shifting the curve to a higher temperature which can result in premature failure of the PTC element. Such increased resistance along with the higher switch temperature reduces the effective output of the PTC element. To reduce the possibility that excess pressure will be applied to the PTC element, while still providing sufficient pressure between the heater sheath 70 and electrodes 20, 22, the heating section 12 includes a means for limiting a compressive force on the PTC element 14.

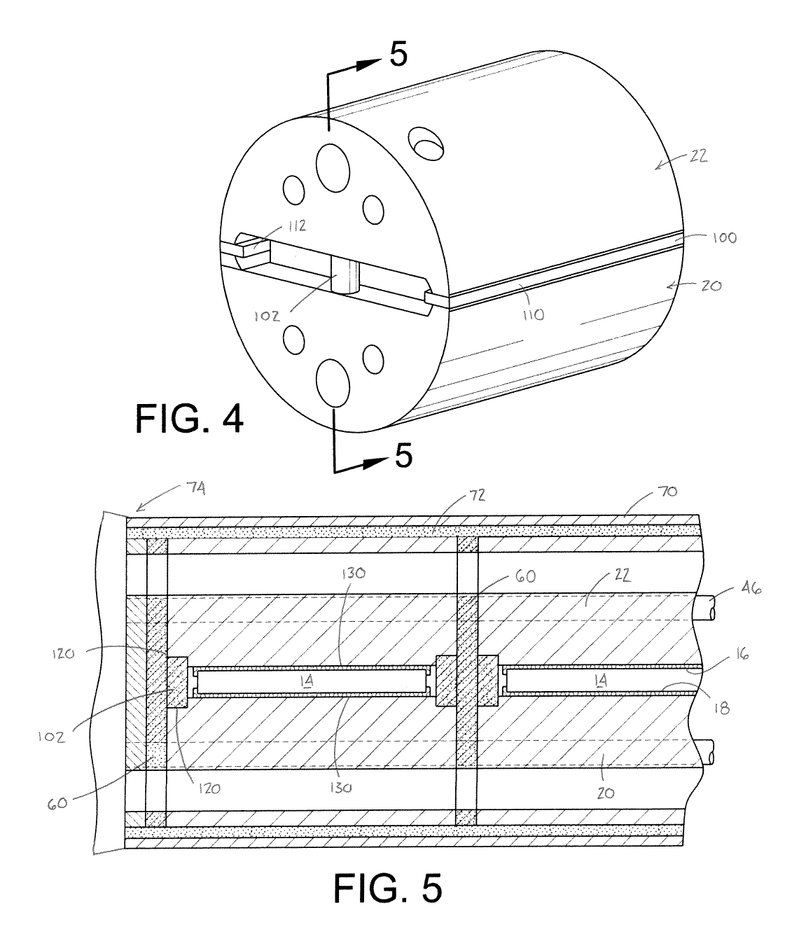

In the depicted embodiment, the means for limiting includes electrically insulative first and second spacer members 100 and 102, respectively, positioned between the first surfaces 30 of the pair of electrodes 20, 22. The first and second ceramic spacer members are designed to allow a desired amount of force to be exerted on the PTC element 14 by the pair of electrodes 20, 22 and by the heater sheath 70 indirectly on the PTC element, via the electrodes. The first spacer members 100, which are generally rectangular in shape, are positioned adjacent at least a section of the periphery of each first surface 30. Particularly, the means for limiting further includes at least one shoulder located on the first surface 30 of each electrode 20, 22. As shown, first and second shoulders 110 and 112, respectively, are located adjacent the first and second sides 90 and 92. With reference to FIG. 4, the first spacer members 100 are positioned between the shoulders of the pair of electrodes. In the assembled condition, a longitudinal axis defined by each first spacer member is parallel to a longitudinal axis defined by the heating section 12. Further, the second surfaces 32 of the pair of electrodes 20, 22 and a first wall 110 of each first spacer member 100 together define a common surface. A second wall 112 of each first spacer member is generally spaced from the PTC element 14.

The second spacer members or stakes 102 connect the pair of electrodes 20, 22. As shown, the second spacer members 102 are generally cylindrical in shape. Each second spacer member 102 is oriented generally normal to the first surfaces 30 of the pair of electrodes and is spaced from the PTC element 14. To secure each second spacer member 102 to the electrodes, at least one first surface of the pair of the electrodes includes an aperture for accommodating an end portion of the second spacer member. In the depicted embodiment, and as shown in FIG. 5, the first surface of each electrode includes an aperture 120 dimensioned to receive an end portion of the second spacer member 102. The second spacer member is configured to limit a compressive force on the PTC element 14.

Due to the precise requirements of pressure on the PTC element 14 for optimum performance, variations in thickness of the assembled components of the heating section 12 can present a problem For example, if the PTC element is too thick or the first spacer members 100 are too thin, too much force can be applied to the PTC element. If the PTC element is too thin and the first spacer members 100 are too thick, insufficient force can be applied to the PTC element resulting in poor electrical and thermal contact. To provide proper force over the tolerance range required for economical manufacture, each heating section 12 can further include an electrically conductive and stress relieving interface pad 130. In the depicted embodiment of FIGS. 3 and 5, two interface pads are provided, each interface pad contacting one of the surfaces 16 and 18 of each PTC element 14. The interface pads 130 are sized to fit between the shoulders 110, 112 located on the first surfaces 30 and have a length slightly larger than the length of the PTC element. This allows end portions of the interface pad 130 to be folded over the PTC element in the assembled condition (FIG. 5). The interface pad 130 can be constructed of a graphite film or compound that would provide good electrical and heat transfer to the surrounding environment from the PTC element 14 when the PTC element is energized. As shown, the interface pad 130 is formed from a corrugated copper material which is configured to be compressed between 50-100% of its formed thickness in order to achieve the proper applied force to the PTC element 14. It should be appreciated by one skilled in the art that other known electrically and thermally conductive interface pads, films or coatings could also be used.

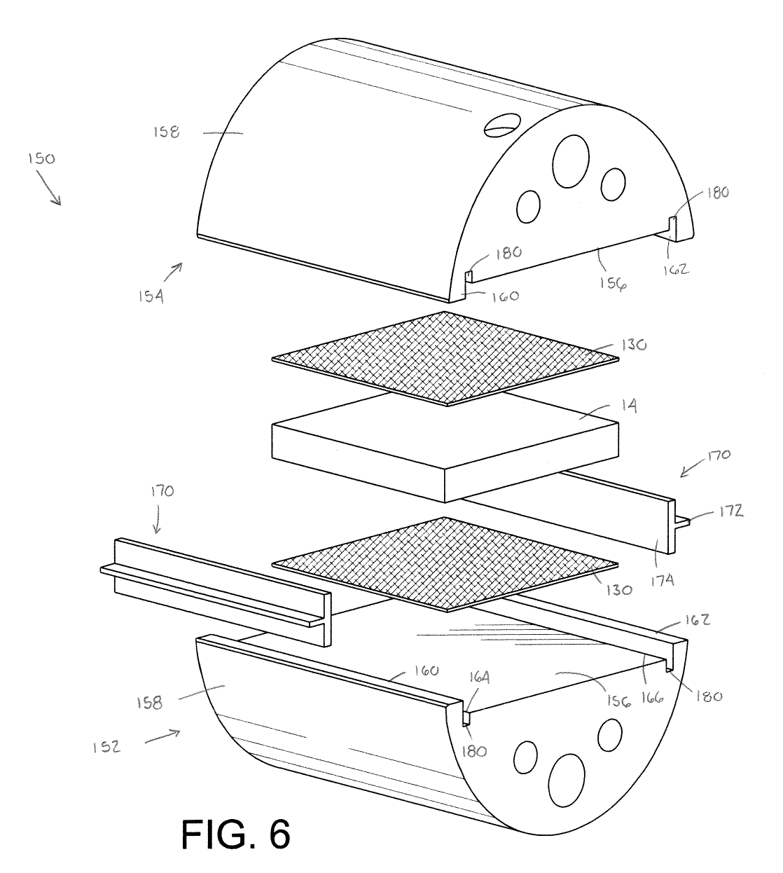

With reference now to FIG. 6, a heating section 150 for the self-regulating heater assembly 10 according to another aspect of the present disclosure is illustrated. Similar to heating section 12 described, the heating section 150 includes the PTC heating element 14 and a pair of spaced apart electrodes 152 and 154. The pair of spaced apart electrodes supports and energizes the PTC element. The electrodes 152, 154 are structurally similar, each electrode having a generally planar first surface 156 and a second surface 158. To limit a compressive force on the PTC element 14, first and second shoulders 160 and 162, respectively, are located adjacent respective first and second sides 164 and 166 of the first surface 156. Interface pads 130 are positioned between each electrode and the PTC element and are sized to fit between the first and second shoulders.

To further limit a compressive force on the PTC element 14, electrically insulative spacer members 170 are positioned between the first surfaces 156 of the pair of electrodes 152, 154. The ceramic spacer members are designed to allow the proper force between the PTC element and the electrodes. Each spacer member 170 is generally T-shaped and includes a stem 172 and a head 174 connected to the stem. In an assembled condition, the spacer members 170 are positioned between the shoulders 160, 162 of the pair of electrodes such that the stems 172 are located on the shoulders and end portions of the heads 174 are received in channels 180. The channels are located on the first surface 156 of each electrode adjacent the shoulders 160, 162. Once assembled, the head 174 of each spacer member 170 is spaced from the PTC element 14 and a longitudinal axis defined by each spacer member is parallel to a longitudinal axis defined by the heating section 150.

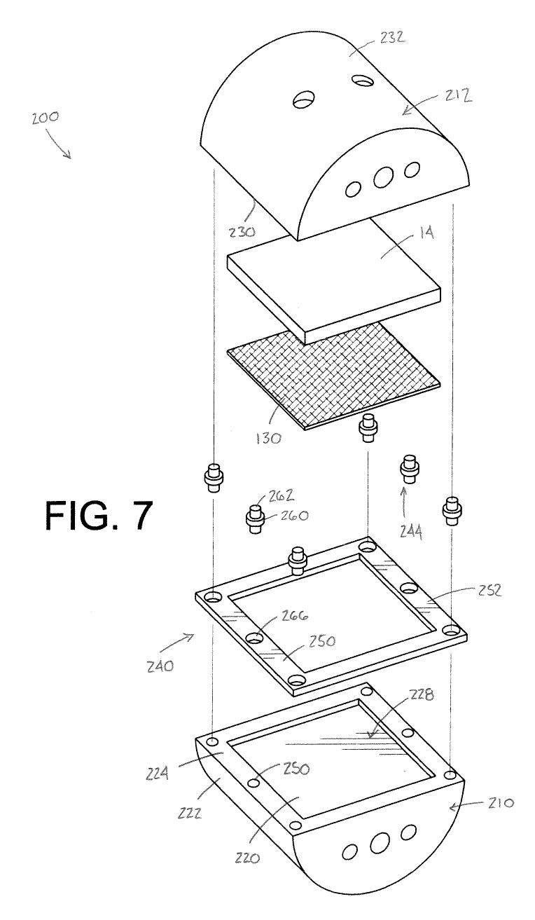

With reference now to FIG. 7, a heating section 200 for the self-regulating heater assembly 10 according to another aspect of the present disclosure is illustrated. The heating section 200 includes the PTC heating element 14 and a pair of spaced apart electrodes 210, 212. The pair of spaced apart electrodes supports and energizes the PTC element. The interface pad 130 is positioned between electrode 210 and the PTC element 14. Electrode 210 has a generally planar first surface 220 and a second surface 222. To limit limiting a compressive force on the PTC element 14, a shoulder 224 extends continuously around a periphery of the first surface 220 of electrode 210. The shoulder and the first surface together define a cavity 228 for accommodating the interface pad 130 and at least a portion of the PTC element 14. Electrode 212 has a generally planar first surface 230 and a second surface 232. It should be appreciated that electrode 212 can have a similar configuration as electrode 210 and a second interface pad can be positioned between electrode 212 and the PTC element 14.

To further limit a compressive force on the PTC element 14, an electrically insulative spacer member 240 is positioned between the first surfaces of the pair of electrodes 210, 212. The spacer member has a generally frame-like configuration such that the spacer member 240 can be positioned on the periphery of the first surface and surround the PTC element 14. The spacer member 240 further includes at least one stub 244. The first surface 220 of the electrode 210 includes at least one hole 250 dimensioned to receive at least one protrusion of the stub of the spacer member. In the depicted embodiment, the spacer member 240 includes six spaced apart stubs 244 arrayed along the sides 252, 254 of the spacer member 240. Electrode 210 includes six corresponding holes 250 located on the shoulder 224 and electrode 212 includes six corresponding holes (not visible) located on the first surface. Each stub includes a hub section 260 which surrounds a cylindrical section 262, the hub section being centrally located on the cylindrical section. The stubs 244 are separate from the spacer member 240 and are mounted to the spacer member by positioning the hub section 260 of each protrusion in a corresponding opening 266 located on the spacer member. Each opening 266 is sized to frictionally receive the hub section 260. The spacer member 240 is secured to the electrodes 210, 212 by positioning end portions of the cylindrical section 262 into the holes 250 of electrode 210 and the holes of electrode 212.

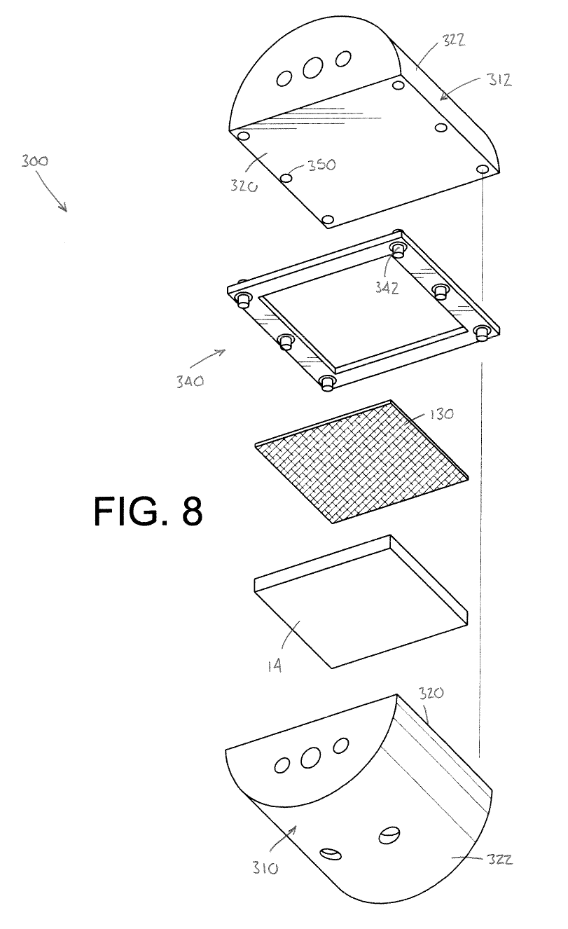

With reference now to FIG. 8, a heating section 300 for the self-regulating heater assembly 10 according to another aspect of the present disclosure is illustrated. The heating section 300 includes the PTC heating element 14 and a pair of spaced apart electrodes 310, 312. The pair of spaced apart electrodes supports and energizes the PTC element. The electrodes 310 and 312 are structurally similar, each electrode having a generally planar first surface 320 and a second surface 322. The interface pad 130 is positioned between electrode 312 and the PTC element 14. It should be appreciated that a second interface pad can be positioned between electrode 310 and the PTC element 14.

An electrically insulative spacer member 340 is positioned between the first surfaces of the pair of electrodes 310, 312. Similar to spacer member 240, spacer member 340 has a generally frame-like configuration such that the spacer member can be positioned on the periphery of the first surface 320 and surround the PTC element 14 to limit a compressive force on the PTC element 14. The spacer member 340 includes six spaced apart, generally cylindrical shaped protrusions 342 arrayed along the sides of the spacer member and extending through the spacer member. In this embodiment, the protrusions are integrally formed with the spacer member. Each electrode 310, 312 includes six corresponding holes 350, each hole being dimensioned to at least partially receive an end section of the protrusion. To mount the spacer member 340 to the electrodes 310, 312, respective end portions of the protrusions 342 are positioned in the holes 350 of the electrodes 310 and 312.

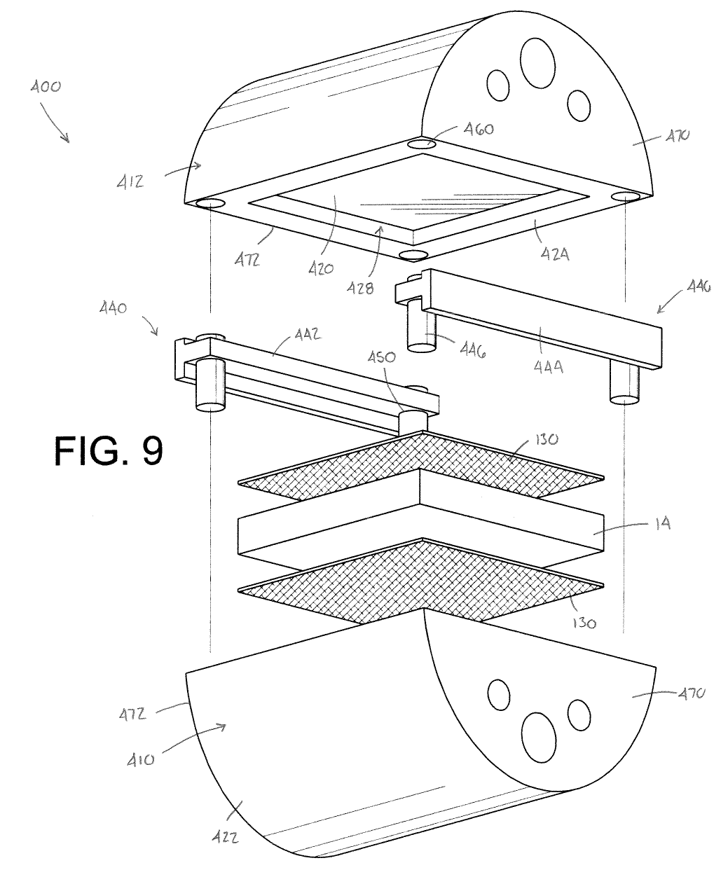

With reference now to FIG. 9, a heating section 400 for the self-regulating heater assembly 10 according to another aspect of the present disclosure is illustrated. The heating section 400 includes the PTC heating element 14 and a pair of spaced apart electrodes 410, 412. The pair of spaced apart electrodes supports and energizes the PTC element. The electrodes 410 and 412 are structurally similar, each electrode having a generally planar first surface 420 and a second surface 422. An interface pad 130 is positioned between each electrode and the PTC element. A shoulder 424 extends continuously around a periphery of the first surface 420 of each electrode 410 and 412. The shoulder and the first surface of each electrode together define a cavity 428 for accommodating the interface pad 130 and at least a portion of the PTC element 14.

Electrically insulative spacer members 440 are positioned between the first surfaces of the pair of electrodes 410, 412. Each spacer member is generally T-shaped and includes a stem or base 442 and a head 444 connected to the base. At least one generally cylindrical shaped protrusion 446 extends through an opening 450 located on the base. As shown, each spacer member 440 includes a pair of protrusions located adjacent respective end portions of the base. A major portion of each protrusion can be located beneath the base 442; although, this is not required. Located on the shoulder 424 of each electrode 410, 412 are holes 460 dimensioned to receive at least a portion of the protrusions 446. In an assembled condition, the spacer members 440 are positioned between the shoulders 424 of the pair of electrodes such that the bases 442 are located on the shoulders and respective end portions of the protrusions 446 are positioned in the holes 460 of the electrodes 410 and 412. The heads 444 are located adjacent end walls 470 and 472 of the electrodes. Once assembled, each spacer member 440 is spaced from the PTC element 14 and a longitudinal axis defined by each spacer member 440 is generally perpendicular to a longitudinal axis defined by the heating section 400.

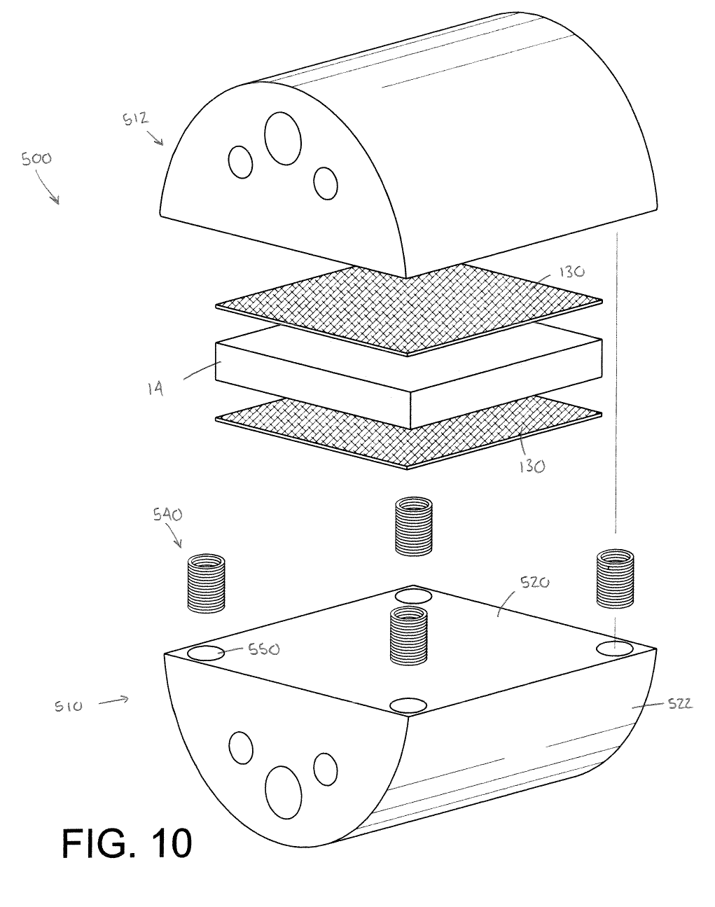

With reference now to FIG. 10, a heating section 500 for the self-regulating heater assembly 10 according to another aspect of the present disclosure is illustrated. The heating section 500 includes the PTC heating element 14 and a pair of spaced apart electrodes 510, 512. The pair of spaced apart electrodes supports and energizes the PTC element. The electrodes 510 and 512 are structurally similar, each electrode having a generally planar first surface 520 and a second surface 522. Interface pads 130 are positioned between electrodes and the PTC element. To limit limiting a compressive force on the PTC element 14, electrically insulative spacer members 540 are positioned between the first surfaces of the pair of electrodes. Each spacer member is configured to be at least partially compressed by the pair of electrodes. More particularly, each spacer member 540 has a generally helical configuration, and the first surface 520 of at least one of the each electrodes 510, 512 includes a hole 550 dimensioned to at least partially receive an end section of the spacer member.

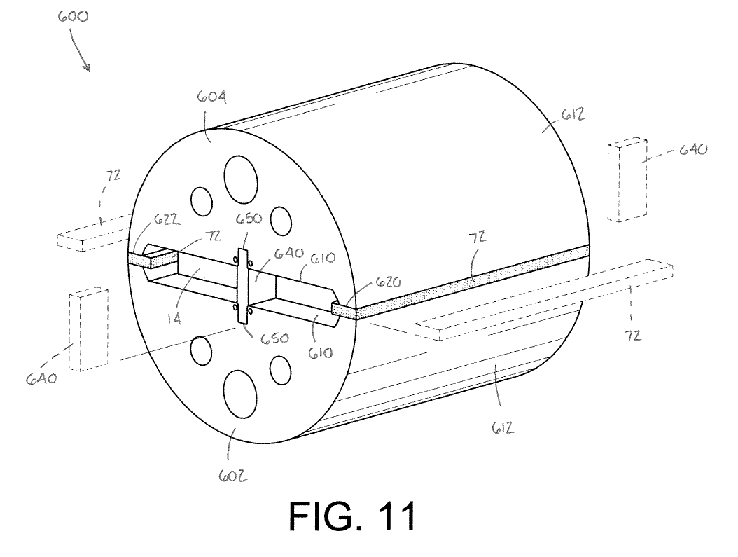

With reference now to FIG. 11, a heating section 600 for the self-regulating heater assembly 10 according to another aspect of the present disclosure is illustrated. The heating section 600 includes the PTC heating element 14 and a pair of spaced apart electrodes 602 and 604. The pair of spaced apart electrodes supports and energizes the PTC element. Interface pads (not visible) can be positioned between electrodes and the PTC element. The electrodes are structurally similar, each electrode having a generally planar first surface 610 and a second surface 612. First and second shoulders 620 and 622, respectively, are located adjacent respective first and second sides of the first surface 610. To limit a compressive force on the PTC element 14, compacted electrically insulative and thermally conductive fill material 72 is located between the shoulders. It should be appreciated that the fill material 72 can only be compacted to a limited extent so that the shoulders of the two electrodes 602 and 604 remain separated.

To further limit a compressive force on the PTC element 14, electrically insulative spacer members or stakes 640 connect the pair of electrodes 602, 604. The ceramic stakes are designed to allow the proper force between the PTC element and the electrodes. As shown, the stakes 640 are generally rectangular in shape. Each stake 640 is oriented generally normal to the first surfaces 610 of the pair of electrodes 602, 604 and is spaced from the PTC element 14. To secure each stake 640 to the electrodes, at least one first surface of the pair of the electrodes includes a slot 650 for accommodating an end portion of the stake. In the depicted embodiment, the first surface of each electrode includes a slot 650 dimensioned to receive an end portion of the stake 640.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A self-regulating heater assembly comprising:
a positive temperature coefficient (PTC) heating element;
a pair of spaced electrodes, each electrode including a first surface, the first surfaces of the pair of electrodes being spaced from one another, wherein the PTC element is located between and supported by the first surfaces of the pair of electrodes and is energized by the pair of electrodes;
means for limiting a compressive force on the PTC element, the means including an electrically insulative spacer member positioned between the first surfaces of the pair of electrodes; and
a first pair of power leads, one power lead being connected to each of the pair of electrodes for energizing the pair of electrodes.

2. The self-regulating heater assembly of claim 1, wherein each first surface of the pair of electrodes includes first and second sides and first and second transverse ends, the first and second sides and the first and second ends defining a periphery of the first surface, the spacer member being positioned adjacent at least a section of the periphery of each first surface.

3. The self-regulating heater assembly of claim 2, wherein the spacer member has a generally frame-like configuration, the PTC element being surrounded by the spacer member.

4. The self-regulating heater assembly of claim 1, wherein the spacer member includes at least one protrusion and at least one first surface of the pair of electrodes includes at least one hole dimensioned to receive the at least one protrusion of the spacer member.

5. The self-regulating heater of claim 1, wherein the means for limiting further includes a shoulder located on the first surface of each electrode, the spacer member being positioned between the shoulders of the pair of electrodes.

6. The self-regulating heater of claim 5, wherein the spacer member is generally T-shaped and at least one first surface of the pair of electrodes includes a channel located adjacent the shoulder, a portion of the spacer member being positioned in the channel.

7. The self-regulating heater of claim 1, further comprising an electrically and thermally conductive, compressible interface pad interposed between and contiguous to the first surface of at least one of the pair of electrodes and a wall of the PTC element.

8. The self-regulating heater assembly of claim 7, wherein the first surface of the at least one electrode includes a cavity for accommodating a portion of the interface pad.

9. The self-regulating heater of claim 7, wherein the interface pad includes a corrugated material.

10. The self-regulating heater assembly of claim 1 further comprising:
a sheath surrounding the pair of electrodes; and
an electrically insulative and thermally conductive fill material, wherein the heater assembly includes a swaged area, a portion of the fill material being located between the pair of electrodes and the sheath being compressed in the swaged area to remove air gaps and voids that impede heat transfer.

11. A self-regulating heater assembly comprising:
a positive temperature coefficient (PTC) heating element;
a pair of spaced electrodes, each electrode including a first surface, the first surfaces of the pair of electrodes being spaced from one another, wherein the PTC element is located between and supported by the first surfaces of the pair of electrodes and is energized by the pair of electrodes;
a stake connecting the pair of electrodes, the stake being oriented generally normal to the first surfaces of the pair of electrodes, the stake comprising an electrically insulative material; and
a first pair of power leads, one power lead being connected to each of the pair of electrodes for energizing the pair of electrodes.

12. The self-regulating heater of claim 11, wherein at least one of the electrodes includes an aperture for accommodating an end of the stake.

13. The self-regulating heater of claim 11, wherein the stake is spaced from the PTC element.

14. The self-regulating heater of claim 11, wherein the stake is configured to limit a compressive force on the PTC element.

15. The self-regulating heater of claim 11, further including a shoulder located on the first surface of each electrode.

16. The self-regulating heater assembly of claim 15, further including an electrically insulative spacer member positioned between the shoulders of the pair of electrodes

17. A self-regulating heater assembly comprising:
a plurality of spaced heating sections, each heating section comprising:
a positive temperature coefficient (PTC) heating element,
a pair of spaced apart electrodes for supporting and energizing the PTC element, each electrode having a generally planar first surface and a second surface;
an electrically insulative spacer member positioned between the first surfaces of the pair of electrodes to limit a compressive force on the PTC element;
an electrically and thermally conductive, compressible interface pad in contact with a surface of the PTC element and disposed between the PTC element and at least one of the pair of electrodes; and
at least one pair of power leads, one being connected to each of the pair of electrodes of each of the plurality of spaced heating sections for energizing each of the heating sections.

18. The self-regulating heater assembly of claim 17, further comprising:
a metallic sheath encasing the heater assembly; and
an electrically insulative and thermally conductive fill material disposed about a portion of each heating section, a portion of the fill material being compressed between the first surfaces of the pair of electrodes of each heating section to further limit the compressive force on the PTC element.

19. The self-regulating heater assembly of claim 17, further comprising an electrically insulative and thermally conductive segment spacing member positioned between adjacent ones of the plurality of heating sections.

20. The heater assembly of claim 18, wherein the heater assembly includes a swaged area for compacting the fill material between the sheath and each of the plurality of heating sections to remove air gaps and voids that impede heat transfer.
